(19) United States
(12) Patent Application Publication
(10) Pub. No.: US 2010/0236426 A1
(43) Pub. Date: Sep. 23, 2010

(54) CONVERTIBLE CUTTING BOARD

(76) Inventors: Anna M. Stewart, Naples, NY (US); Stephen Kraigh Stewart, Naples, NY (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/407,462

(22) Filed: Mar. 19, 2009

(51) Int. Cl. A47J 47/00; B23Q 3/00

(52) U.S. Cl. 99/645; 269/289 R

(57) ABSTRACT

A convertible cutting board is a system or apparatus that provides its user with a surface suitable for the preparation of food as well as an integral means to cover or seal food for storage without having to remove the food from the preparation surface. Advantageously, a convertible cutting board system provides a user access to food contents sitting atop the cutting surface without the requirement that the cutting surface be removed from a larger container or that a dome element be de-communicated. Further, embodiments of a convertible cutting board system feature a retractable dome element that collapses when access to food on the cutting surface is required. Also, some embodiments feature a dome element operable to provide an air-tight seal when in the closed position. Still other embodiments provide a means by which the food preparation surface may be separated from the system but, importantly, separation from the system is not required in order to gain access to stored food.

### CROSS-REFERENCE TO RELATED APPLICATIONS

This application is related to co-pending U.S design patent applications entitled “Rotatable Cover” and “Retractable Canopy Cover,” filed concurrently with the present application on Mar. 19, 2009 and accorded attorney docket numbers 06011.1140 and 06011.1150, respectively. The aforementioned related applications are herein incorporated by reference in their entirety.

### BACKGROUND

The present invention relates to food preparation and storage systems and, more particularly, to food preparation and storage systems having a removable or retractable cover device.

Cutting boards or, even more generally, any surface designated for food preparation, are common place in modern-day kitchens. In fact, most kitchens are equipped with multiple cutting boards, some used for meat carving, others earmarked for vegetable preparation, and still others reserved for bread slicing or other tasks. Regardless of a cutting surface's designated use, or uses, food is usually prepared on its surface with intent to be served as victuals. And, where food is served, there is very often excess, leftover, or unused food that must be discarded or stored for later consumption.

Using bread as an example, it is not out of the ordinary for a loaf of bread to be sliced on an “as needed” basis. Many people bake or purchase fresh bread loaves and consume the product of provender one slice at a time. Each time the desire for another slice arises, the loaf, or the remainder thereof, is pulled out of its storage, placed on a cutting surface and carved accordingly. After the desired amount is removed, the remainder of the loaf, if any, is again stored away in anticipation of the next meal.

In the previous example, the bread lover makes use of both a bread cutting surface as well as a separate bread storage device. Some bread storage devices, however, are capable of simultaneously containing the bread along with the cutting board on which the bread sits. Such an arrangement is convenient as the bread remains fresh inside the bread storage device, the cutting board required for its preparation is efficiently stored with the bread, and there is no need to clean the cutting board of crumbs until after all the bread is consumed. The disadvantage of such a system, however, is that the cutting board, and bread, must be removed from the bread storage apparatus before the bread can be sliced.

Another common combination food preparation and storage system known in the art is the cake plate with removable cover. Some cake plates, or cake stands, are fitted with a groove, or some other profile, running circumferentially around the edge of the plate such that a dome-like top can be securely fitted over a cake sitting in its center. Still other cake plate/storage systems opt for better sealing designs in an effort to maintain the freshness of the cake stored within. Regardless of the specific design or chosen materials of construction, each such system currently known in the art requires that the dome, or top, be an element that is completely separable from the underlying cake plate such that the cake can be exposed for slicing.

The disadvantage of the current art, among others, is that the cutting surface element and the food storage element are not integral to one another. With a cake plate/dome combination, for example, the cake can certainly be sliced without being removed from the cake plate. Further, the remainder of the cake may be stored for later consumption without removing it from the plate, as the dome is operable to simultaneously sit atop the cake plate and over the cake. The cake plate and dome, however, are two distinctly separate components of the cake plate/dome system such that the dome must be completely disconnected with the cake plate in order for access to the cake to be gained.

Similarly, a common bread box apparatus large enough to accommodate a cutting board, or some other food preparation surface, is equally cumbersome as the previously described cake plate/dome system in that the bread box and cutting board are distinctly separate components. While food could be stored on top of a cutting board that is slid into a large bread box, access to the food would be inefficient as the cutting board would have to be removed from the bread box in order for access to the food to be gained.

Therefore, what is needed in the art is a system that combines the functionality of a food preparation surface with an integral food storage device. Such a system would enable a user to combine the functionality of multiple common kitchen devices into a single, convenient and compact system.

### BRIEF SUMMARY

A food preparation surface with sealable open/close canopy is a convertible cutting board system that provides its user with a surface suitable for the preparation of food, i.e. a cutting board or the like, as well as an integral means to cover or seal food for storage without having to remove the food from the preparation surface. The closest art to the present convertible cutting board system is a cake plate and dome combination or a bread box system large enough to accommodate a cutting board.

As opposed to the prior art, a convertible cutting board system advantageously provides a user access to food contents sitting atop the cutting surface without the requirement that the cutting surface be removed from a larger container or that a dome element be de-communicated. Further, embodiments of a convertible cutting board system feature a retractable dome element that collapses when access to food stored on the cutting surface is required. Moreover, some embodiments feature a dome element operable to provide a substantially air-tight seal when in the closed position. Also, aspects or features of various embodiments may include operability to condition the moisture content or temperature of stored food. Still other embodiments provide a means by which the food preparation surface may be separated from the system but, importantly, separation from the system is not required in order to gain access to stored food.

### BRIEF DESCRIPTION OF THE SEVERAL VIEWS OF THE DRAWING

FIG. 1 is a perspective view of one embodiment of a food preparation surface with a sealable open/close canopy, shown with the canopy in the closed/sealed position.

FIG. 2 is a top view of one embodiment of a food preparation surface with a sealable open/close canopy, shown with the canopy in the closed/sealed position.

FIG. 3 is a frontal or rear view of one embodiment of a food preparation surface with a sealable open/close canopy, shown with the canopy in the closed/sealed position.

FIG. 4 is a perspective view of one embodiment of a food preparation surface with a sealable open/close canopy, shown with the canopy in a partially open position.

FIG. 5 is a top view of one embodiment of a food preparation surface with a sealable open/close canopy, shown with the canopy in a partially open position.

FIG. 6 is a frontal or rear view of one embodiment of a food preparation surface with a sealable open/close canopy, shown with the canopy in a partially open position.

FIG. 7 is a perspective view of one embodiment of a food preparation surface with a sealable open/close canopy, shown with the canopy in a fully open position.

FIG. 8 is a top view of one embodiment of a food preparation surface with a sealable open/close canopy, shown with the canopy in a fully open position.

FIG. 9 is a frontal or rear view of one embodiment of a food preparation surface with a sealable open/close canopy, shown with the canopy in a fully open position.

FIGS. 10A and 10B, collectively FIG. 10, are drawings that illustrate one embodiment of a connection to secure the cover components to each other.

FIG. 11 is a perspective block-style depiction of an embodiment of a food preparation surface with a sealable open/close cover arrangement, shown with the cover arrangement in a partially open position.

FIGS. 12A and 12B, collectively referred to as FIG. 12, are diagrams illustrating views of another embodiment of the present invention in an open state (FIG. 12A) and a closed state (FIG. 12B).

FIG. 13 is a perspective view of an alternate canopy aspect included in some embodiments of the present invention, the alternate canopy being depicted in a closed position.

FIG. 14 is a perspective view of an alternate canopy aspect included in some embodiments of the present invention, the alternate canopy being depicted in a partially open position.

FIG. 15 is a perspective view of an alternate canopy aspect included in some embodiments of the present invention, the alternate canopy being depicted in a fully open position.

FIG. 16 is a perspective view of an embodiment of a food preparation surface with a sealable open/close cover arrangement, the cover arrangement being comprised of a single canopy.

### DETAILED DESCRIPTION

Embodiments and aspects of the convertible cutting board system provide a solution to the above-described needs in the art, as well as other needs in the art, by presenting a food preparation surface with an integral open/close canopy. Advantageously, the canopy element of the convertible cutting board system defines a space over the cutting board, when in a closed position, and is operable to retract to an open position in order to provide a user unobstructed access to food.

More specifically, a food preparation surface with sealable open/close canopy is a convertible cutting board system that provides its user with a surface suitable for the preparation of food, i.e. a cutting board or the like, as well as an integral means to cover or seal food for storage without having to remove the food from the preparation surface.

Various embodiments, implementations and structures for a convertible cutting board system are presented herein and it should be appreciated that although certain features, aspects, embodiments, implementations and/or structures may in and of themselves constitute patentable inventions, the disclosure is not limited by any particular embodiment.

One non-limiting example of a convertible cutting board system comprises a base component operable to receive a removable food preparation surface. The food preparation surface, when received by the base, is oriented in a level manner and substantially prevented from shifting within the parameters of the base. It should be appreciated that the present embodiment is being offered as a non-limiting example of a convertible cutting board system and, therefore, should not be interpreted as a limitation on the scope of the claims. For example, while the particular exemplary embodiment being presently described comprises a removable food preparation surface, other embodiments of a convertible cutting board system may feature a food preparation surface that is permanently attached to, or integrally a part of, the system base component.

The base of the exemplary system, as well as the nested food preparation surface, can be provided in a variety of shapes, rectilinear or otherwise. A few non-limiting examples include circular, rectangular, square, oval, diamond, triangular, elliptical, etc. In a particular embodiment described herein, the base is in the shape of an oval. Communicating along the top circumference of the base component and pivotally anchored or secured at either end of the shortest diameter thereof is two retractable dome elements. Each dome element, when fully extended from its retracted state, takes the form of a portion of a three-dimensional oval that ranges at least from 0 radians to π/2 radians. Fully extended, the two dome elements mechanically mate along a plane that is substantially perpendicular to the plane defined by the food preparation surface and combine to effectuate a dome structure that defines an internal space suitable for containing food.

At the corners of each dome, roughly on plane with the food preparation surface, are knobs, or some other means, communicable to each dome for the purpose of actuating the dome from a closed position to an open position and vice versa. Further, each dome element is comprised of an alternately creased material such that the dome element is operable to retract upon itself into a collapsed state. Notably, when in a collapsed state, the dome elements expose the food preparation surface for use.

A convertible cutting board system, as described prior, is a food preparation surface with an integral, open/close canopy. As mentioned prior, it is an advantage of the convertible cutting board system that the canopy element of the system is operable to protect food residing on the cutting board, when in a closed position, as well as retract to an open position in order to provide a user unobstructed access to the food. More specifically, the system provides a user with a surface suitable for the preparation of food, i.e. a cutting board or the like, as well as an integral means to cover or seal food for storage without having to remove the food from the preparation surface. The cover to the system is integral and, therefore, while specific designs and features of various cover elements for various system embodiments may be novel, should not be taken as a limiting factor in the scope of the invention.

In various embodiments, the cover element may be constructed in a variety of manners. One already disclosed embodiment includes a creased material such that the dome element is operable to retract upon itself into a collapsed state. Other embodiments of the cover may include of a series of hinged panels, as opposed to the creased or accordion-like embodiment described prior. An exemplary convertible cutting board system with a cover element comprising a series of hinged panels may feature a square base with an integrated food preparation surface. Along one side of the base, from corner to corner, a first panel is hinged such that it can be folded under the base or locked in a position that defines a plane substantially perpendicular to the food preparation surface.

With the first panel in a locked position defining a plane substantially perpendicular to the base, a second panel and third panel are hinged to its vertical sides such that each can be locked in a position defining planes substantially perpendicular to the plane defined by the first panel and communicating along an edge of the base component. A fourth panel hinges along either edge of the second or third panel that is distal to the first panel such that it is operable to communicate along an edge of the base component and define a plane substantially parallel to that which is defined by the first panel.

A fifth, and final, panel is hinged along the top edge of the first panel such that it can simultaneously communicate along the top edges of panels 1 through 4 when each is locked in a position that communicates with the base. With each panel in a locked position and the fifth panel secured along the top edges of the other four panels, a box-like space is defined over the food preparation surface. Advantageously, a hinged, paneled embodiment of a dome component for a convertible cutting board system, such as that disclosed herein, is operable to fold back upon itself and create a stack of nested panels that can be positioned beneath the food preparation base for compact storage when the system is not in use. Alternatively, when the system is being used to store food, the panels can be folded out of the way in order to gain access to the food.

In addition to variations in the design of the cover element, various embodiments of a convertible cutting board system may also incorporate additional features into the food preparation surface aspect. As has been previously disclosed, the food preparation surface aspect may be separable from the base component in some embodiments while in other embodiments it may be integral to the base component. Furthering the variations in the design of the food preparation surface aspect of system embodiments, a non-exhaustive list may include warming or cooling features.

For example, a food preparation surface for some embodiments of a convertible cutting board system may be constructed such that a hermetically sealed cavity within the surface body contains a gel, or some other substance, useful for affecting an accelerated transfer of energy out of any food residing on the exterior of the preparation surface. Alternatively, a similar food preparation surface design may be constructed of different materials that provide an efficient means for the transfer of energy into any food residing on the surface, perhaps for keeping food at a safe serving temperature. Even further, a variation of this variation may provide a non-hermetically sealed cavity within the food preparation surface component that can accommodate ice packs or other heat transfer apparatuses known in the art. In addition, the surface may include a reservoir with a lid that can be opened to allow substances to be placed into the reservoir, such as cold liquid, hot liquid, etc.

Even further, as previously postulated, it is anticipated that embodiments of a convertible cutting board system may encompass features, aspects or subsystems that, in and of themselves, may be patentable. Even so, the inclusion, or exclusion, of such novel features, aspects or subsystems should not limit the scope of the claimed matter. A non-limiting example of an anticipated subsystem that may be included in some embodiments of the convertible cutting board system is a moisture monitoring and additive system. Such a subsystem included in an embodiment of a convertible cutting board system might be useful for regulating and maintaining the moisture content, and its associated freshness, of food stored within the system. It is foreseeable that such a subsystem may be as simple as those known in the art of humidors or as complicated as a moisture monitoring instrument communicating with an electronic controller that actuates spray nozzles connected to a pressurized moisture source.

Turning now to the figures, various embodiments, features and aspects of the convertible cutting board system are more particularly described where like labels represent like elements throughout the drawings. Through the following description of the figures, various aspects, features and embodiments of the convertible cutting board system will be presented in more detail; however, the examples as set forth in the drawings and detailed description are provided by way of explanation of the convertible cutting board system and are not meant as limitations. The convertible cutting board system thus includes any modifications and variations of the following examples as come within the scope of the appended claims and their equivalents.

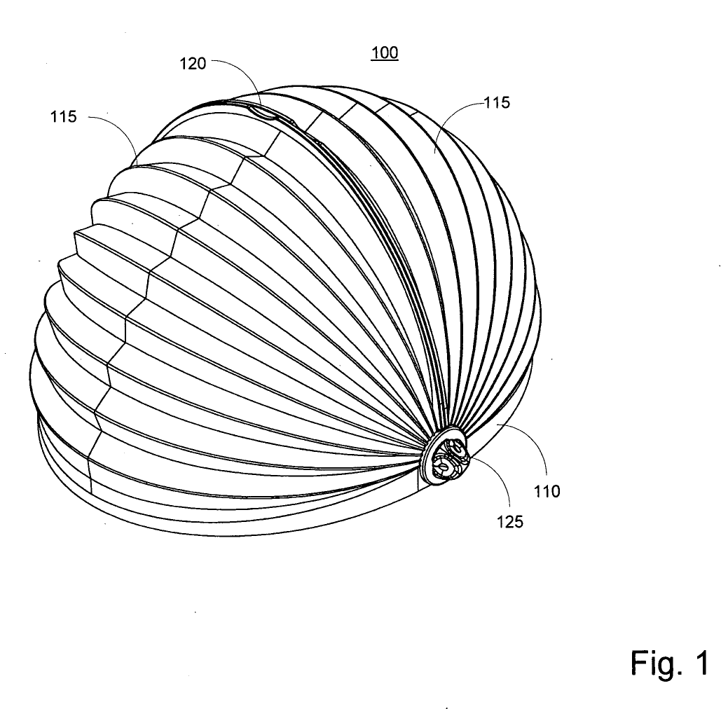

FIG. 1 is a perspective view of one embodiment of a food preparation surface with a canopy. In the illustrated embodiment, a base component 110 includes a canopy 100 which is shown as being in the closed/sealed position. The base component 110 provides the main foundation for the system. Though not specifically shown in the drawing, it should be appreciated that the base component 110 may feature feet, or other profile variations, on its underside useful for raising the system off a surface, providing a co-efficient or degree of friction to prevent sliding, or creating other aspects known in the art. Further, the base 110 may include an integral surface on its top (not shown) useful for preparing or serving food or, alternatively, the base may serve as a receiver for a separable food preparation surface.

The canopy 100, which is operable to extend over the base component 110 and form a covering that defines a space, includes two cover components 115. Each cover component 115 is constructed of an alternately creased material such that it can extend or retract such as in an accordion fashion. The cover components 115 are pivotally attached to the base 110 by connector 125 along an axis that dissects the plane of the base component 110. In addition, the cover components may be connected along the contour of the base 110 to ensure that the covers 115 and the base 110 are not separated creating a gap. The upper portions (the portions not connected to the base 110) of the two covers 115 can be pivotally lifted so that their edges are joined with each other on a plane substantially perpendicular to a plane defined by the base component 110. The cover components 115 may include an interlocking feature, such as a tongue and groove connector or the like that operates to secure and seal the two cover components 115 together along the edge 120.

Located at either end of the axis that dissects the base component 110, and centered on the plane defined by the sealing joining edge 120 of the cover components 115, are connectors 125 (only one shown) which are illustrated as including a knob. In some embodiments, the knobs 125 may be constructed so as to facilitate opening and closing of the canopy 100. For instance, in one embodiment, the knobs may convert an applied force such that the cover components 115 may be extended or retracted. It should be appreciated that various methods and mechanisms for extending or retracting various cover components comprised within various embodiments of a convertible cutting board system may be utilized in different embodiments. Regardless, that which is described herein is offered as a non-limiting example and variations should not limit the scope of the invention.

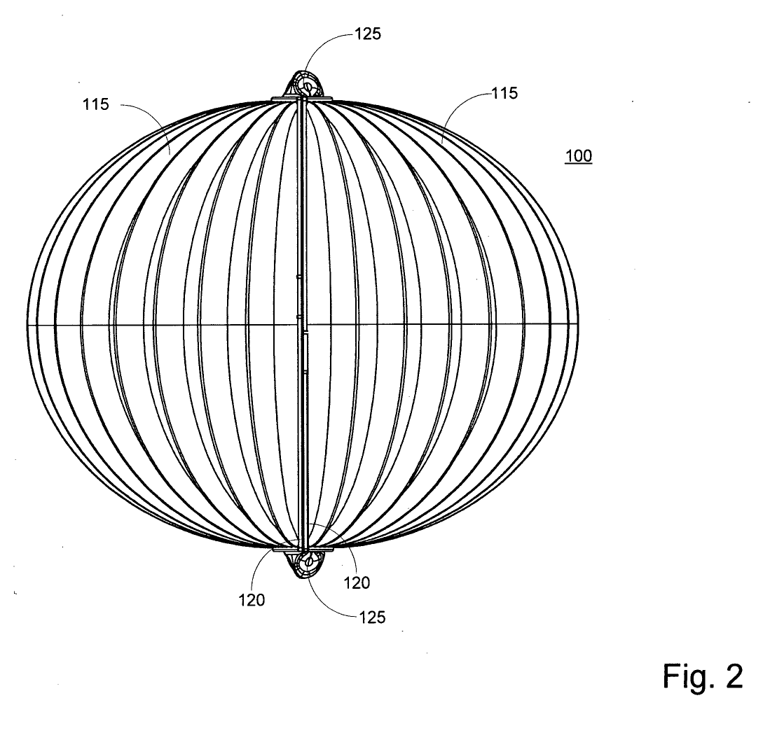

FIG. 2 is a top view of the same embodiment of a food preparation surface with a canopy as shown in FIG. 1, shown with the canopy in the closed position. As described relative to FIG. 1, the canopy 100 cover components 115 are adjoined or meet along interface 120 when the cover components 115 are in the fully extended positions. Further, both knob features 125 can be seen in the top view as located at either end of the axis through the base component 110, and centered on the plane defined along interface 120 of the cover components 115.

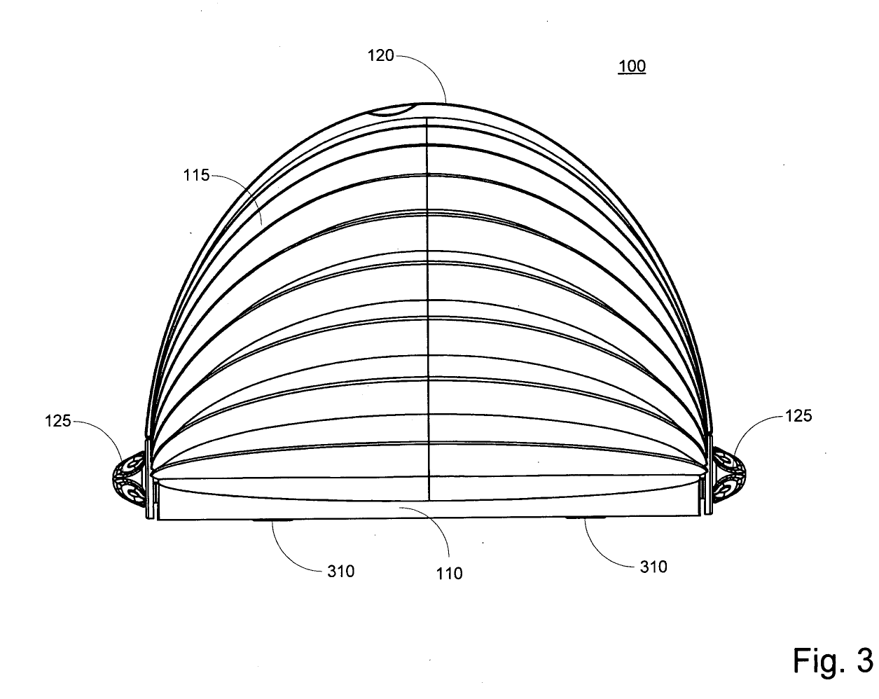

FIG. 3 is a frontal or rear view of the system embodiment presently described, shown with the canopy in the closed position. Notably, the particular embodiment depicted in the figures is of a symmetrical design such that a front or rear view is identical. Design symmetry, however, is not required within all embodiments of the convertible cutting board system and, therefore, should not be a limiting factor in its scope.

It can be seen in FIG. 3 that the cover components 115 define a dome-like structure when fully extended and adjoined along the interface line 120. Further, the interface lines 120 of each cover component 115, when in the closed position, operate to define the uppermost boundary of the system. Also illustrated in FIG. 3, both knob features 125 can be seen as located at either end of the axis through the base component 110. Additionally, even though not featured on all embodiments of a convertible cutting board, the particular embodiment depicted in FIG. 3 features raised profiles, operable as feet, on the underside of the base 110.

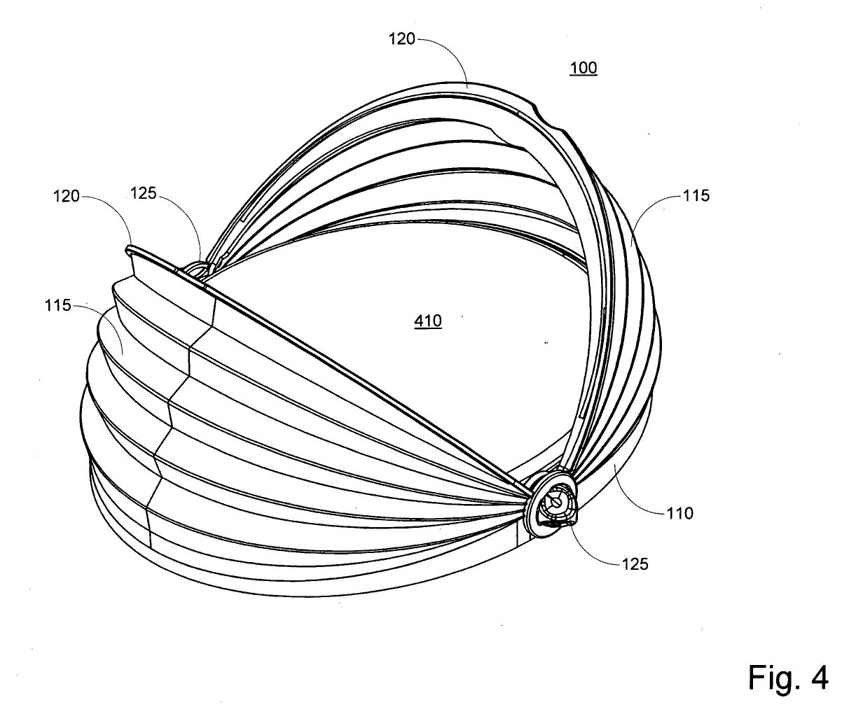

Turning now to FIGS. 4 through 6, the exemplary embodiment presently described is depicted in a semi-open state. As described prior, a convertible cutting board system is unique in that it is multi-functional, providing a food preparation surface with an integral means for storage of food. The food stored within embodiments of the system is easily accessed by retracting the cover elements and, in the alternative, conveniently stored by extending the same.

FIG. 4 is a perspective view of one embodiment of a food preparation surface with a canopy, shown with the canopy 100 in a partially open position. As shown in FIG. 4, the base component 110 provides a foundation for the system as a whole. The top of the base component 110 advantageously functions as a food preparation surface 410 and, as described prior, the surface 410 may be integral to the base 110 or, alternatively, the base may serve as a receiver for a separable food preparation surface 410.

Operable to extend over the base component 110 and form a canopy that defines a space over the food preparation surface 410, two cover components 115 are shown in a partially retracted position. Each cover component 115 is constructed of an alternately creased material such that it can extend or retract in an accordion-like fashion. The cover components 115 are operable to communicate with each other on a plane substantially perpendicular to a plane defined by the base component 110. At the point of communication, each cover component 115 features a sealing aspect 120 operable to mechanically mate with the other.

Located at either end of a central axis on the base component 110, and centered on the intersection of the planes defined by the sealing aspects 120 of the cover components 115 and the food preparation surface 410, are two knobs 125. The knobs 125 are operable to convert an applied force such that the cover components 115 may be extended or retracted.

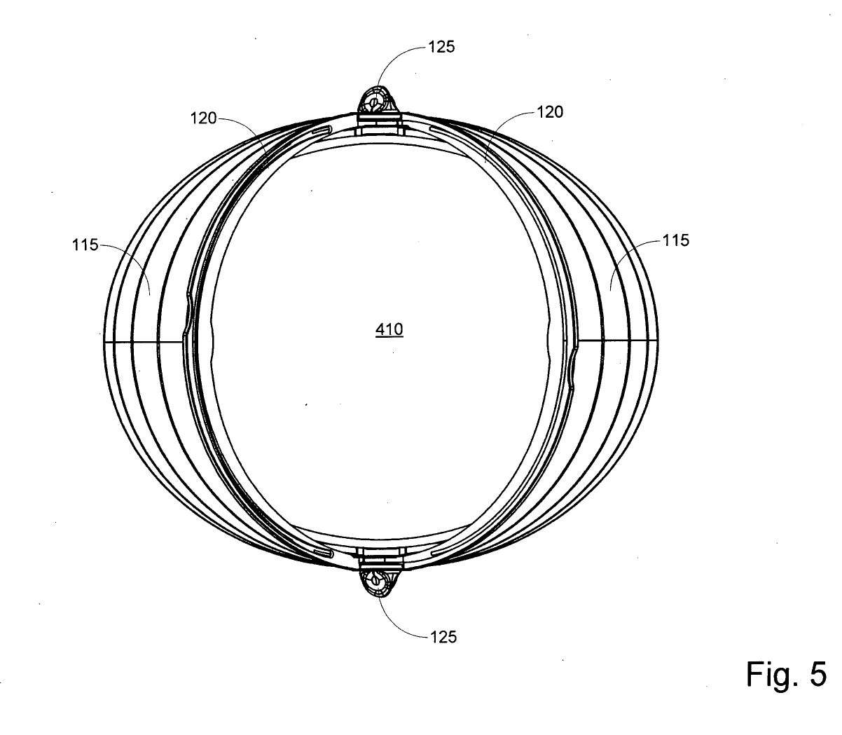

FIG. 5 is a top view of one embodiment of a food preparation surface with a canopy, shown with the canopy 100 in a partially open position. As described relative to FIG. 4, the cover components 115 are shown in a partially retracted state. Further, both knob features 125 can be seen in the top view as located at either end of the axis through the base component 110. Also, the food preparation surface 410 is partially exposed as the cover elements 115 are retracted.

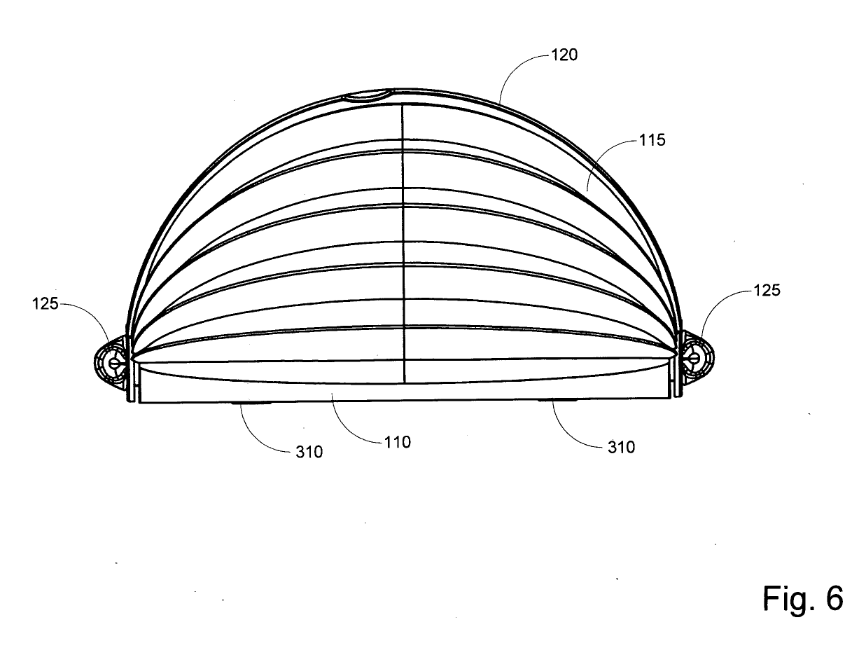

FIG. 6 is a frontal or rear view of the present embodiment of a food preparation surface with the canopy 100, shown with the canopy 100 in a partially open position.

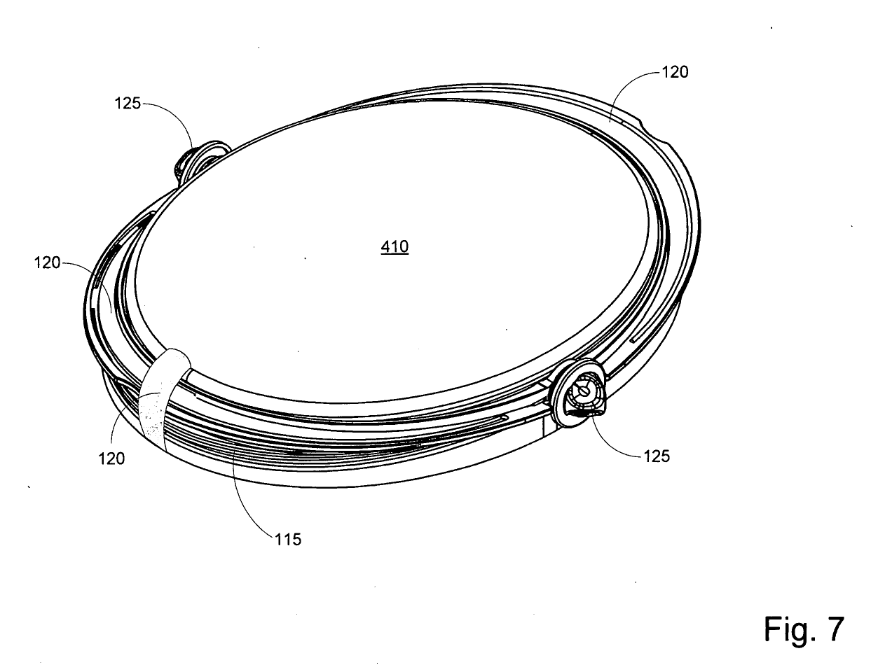

FIG. 7 is a perspective view of an exemplary embodiment of a food preparation surface with a canopy 100, shown with the canopy 100 in a fully open position. With the cover components 115 fully retracted, the food preparation surface 410 is completely exposed and, advantageously, access to food residing on its surface 410 is uninhibited by the cover elements 115. Further, in the particular embodiment shown, the cover elements 115, when fully retracted, are compressed in an accordion-like manner and constrained by the geometry of the base 110. Advantageously, when the cover elements 115 of the present embodiment are positioned in the fully retracted state, the convertible cutting board system is easily stored in a stacked manner with other baking trays or similarly shaped apparatuses. Additionally, even though not featured on all embodiments of a convertible cutting board, the particular embodiment depicted in FIG. 7 features a means 710 for securing the canopies 115 such that inadvertent expansion of the canopies 115 may be prevented.

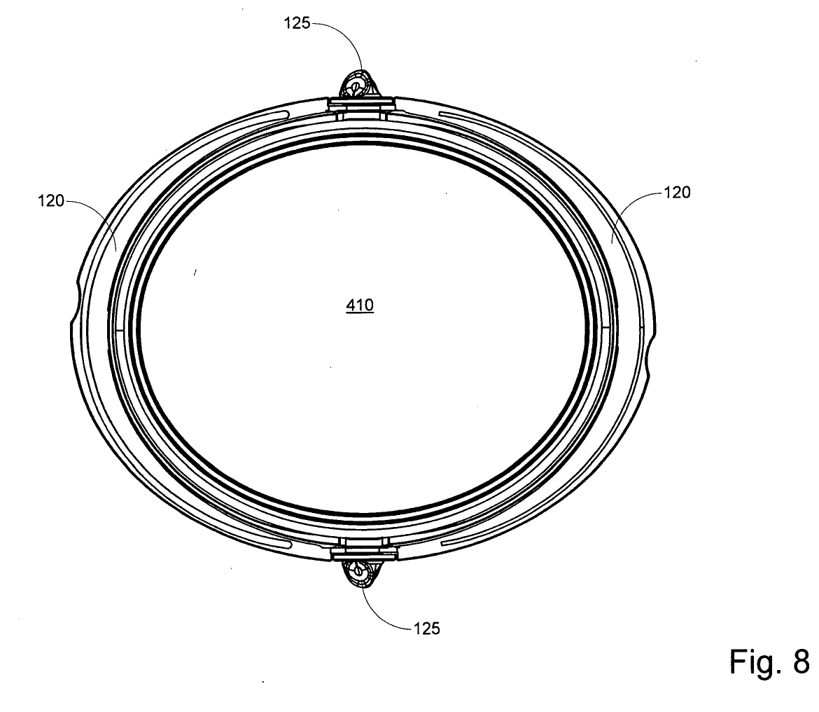

FIG. 8 is a top view of the embodiment of the food preparation surface with the canopy 100 shown in a fully open position. As described relative to FIG. 7, the fully retracted cover elements 115 operate to provide uninhibited access to the food preparation surface 410. From the top view, it is shown that the interfacing edges 120 located along the leading edge of the cover elements 115 are roughly on plane with the food preparation surface 410.

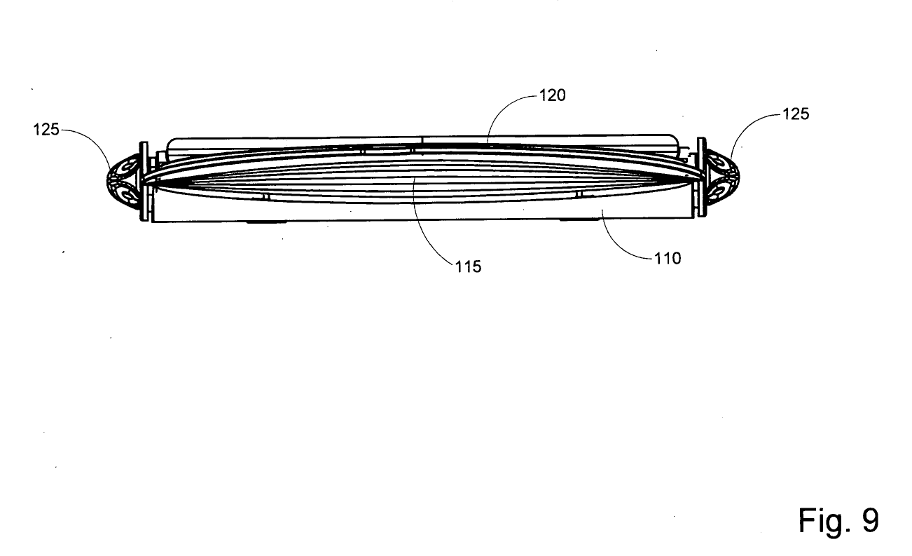

FIG. 9 is a frontal or rear view the embodiment of a food preparation surface with a canopy in the fully open position. When fully opened, the cover elements 115 compress in an accordion-like manner and are contained within the geometry of the base component 110. The cover elements are roughly on plane, or below plane, with the food preparation surface 410.

It should be appreciated that although detailed drawings and descriptions have been provided for the above-presented food preparation surface with a canopy, that many other embodiments may also be utilized. Several alternate embodiments are now presented.

In one alternate embodiment, rather than having two cover components to create the canopy, a single component may be utilized in creating the canopy. In such an embodiment, the canopy will be attached to one end of the base and the other end of the canopy can be pivoted over the base and then attached to the other end of the base to form a complete canopy.

In another alternate embodiment, the base may include a substantially perpendicular back wall that can operate as a back splash or simply to prevent items from falling off of the back side of the cutting board. In such an embodiment, the canopy may be attached to the top of the vertical wall and then pivotally rotated to cover the base when so desired. Alternatively, the canopy may be affixed to the lower portion of the base and then pivotally rotated on its side to be adjoined to the vertical wall.

It will be appreciated that rather than a vertical wall, walls at various angles may also be used in various embodiments of the invention.

The canopy has been described as including alternating creases forming a fan or accordion-like structure. However, those skilled in the art will appreciate that a variety of alternate structures may also be utilized. In one embodiment, the canopy may be constructed out of a series of interlocking and telescoping components such that when the canopy is moved to a closed position, the components are telescoped to a fully extended position and then prevented from further extensions by a flange or interlocking structure. To open the canopy, the components are then retracted to be parallel with each other in a stacked fashion thereby allowing access to the base. In another embodiment, the canopy may be constructed of easily folded plastic, Mylar or cloth-type material. In yet another embodiment, the canopy may be constructed such that it can be extracted off a spring roller into a closed position and then retracted to an open position. Those skilled in the art will appreciate that other structures may also be utilized in various embodiments.

It should be appreciated that in some embodiments, the canopy may be detachable from the base to facilitate cleaning. In addition, various attachment techniques may be used to connect the canopy to the base and the interfacing edges of the canopy. For instance, a typical snap-in connector (common in many TUPPERWARE and other plastic container devices) can be used to connect the canopy to the base. Similarly, a ZIPLOCK type mechanism may also be used to connect the canopy material to the interfacing canopy edges. Those skilled in the art will appreciate that a wide variety of techniques are available for fastening of system components. For example, similar techniques to those outlined above may also be used to join the canopy interface edges of the two cover components together. Alternatively, a latching mechanism may also be used to adjoin the cover components of the canopy.

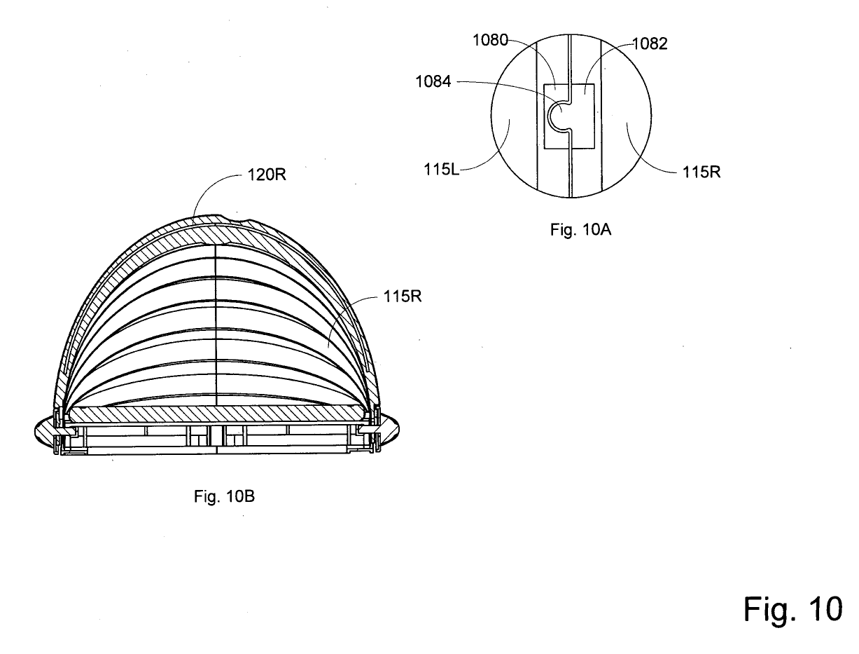

FIGS. 10A and 10B, collectively referred to as FIG. 10, present a diagram illustrating one embodiment of an interface between the cover components. The two cover components 115 have been previously described as interfacing to each other along edge 120. In FIG. 10A, an exemplary interlocking feature is illustrated to show how the two cover components can be secured together and provide some level of air tightness.

In the illustrated embodiment, a left side cover component 115L of canopy 100 includes a receptacle indentation 1080 and the right side cover component 115R of canopy 100 includes a protrusion 1082. As best illustrated in FIG. 10B, the protrusion 1082 is a strip that is affixed to, integrated with, or molded within the edge 120R of the right side cover component 115R. Not shown, the receptacle indentation 1080 is similarly situated along the edge 120 of the left side cover component 115L. In the illustrated embodiment, the receptacle indentation 1080 and the protrusion 1082 are shown as substantially extending over the entire edge 120. However, in some embodiments it will be appreciated that the receptacle indention 1080 and protrusion 1082 only exist on a small portion of the edge 120 or at multiple locations over the edge 120. In other embodiments, the receptacle indentation 1080 and the protrusion may extend over the entire edge 120. In yet other embodiments, the receptacle indentation 1080 and protrusion 1082 may extend over the entire edge 120 in multiple strips, thereby providing even further air-tightness. Also, for some embodiments, the protrusion 1081 and receptacle indentation 1080 may be alternatively featured on either the left 115L or right sided cover component 115R.

In the illustrated embodiment, the protrusion 1082 includes a rounded bulb 1084 and the receptacle indentation 1080 defines a cavity 1086 that is suitably shaped to receive the bulb 1084 and create a “snap” or ZIPLOCK type closure feel. Other embodiments may include other types of structures such as snaps, hooks, VELCRO or other hook and loop structures, magnetic attraction, adhesive, or any of a variety of other techniques. Further and as previously described, the cover components 115 may be fixedly or removably attached to the base 110 using any of the aforementioned techniques.

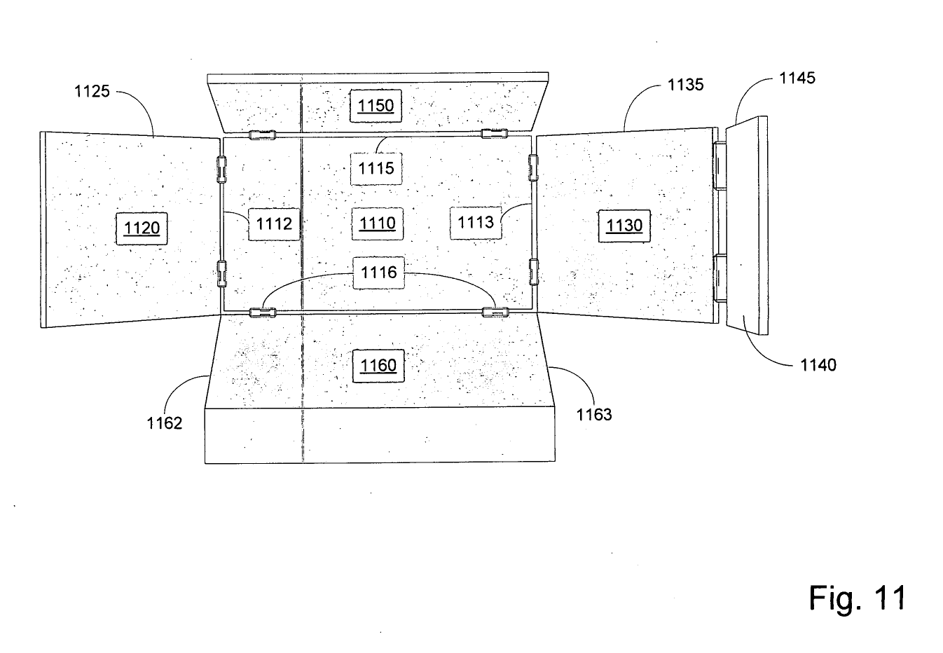

Moving now to FIG. 11, an alternative embodiment of a convertible cutting board system is offered for exemplary purposes. As is common to embodiments of a convertible cutting board system, the FIG. 11 embodiment provides a food preparation surface in conjunction with an integral means for defining a space useful for food storage.

FIG. 11 is a perspective block-style depiction of an embodiment of a food preparation surface 1160 with a sealable cover arrangement, shown with the cover arrangement in a partially open position. Offered as an example of a variation for the cover element in some embodiments, a cover mechanism depicted in the FIG. 11 embodiment may be comprised of a series of hinged panels 1110, 1120, 1130, 1140, 1150, as opposed to the accordion-like embodiment described prior. An exemplary convertible cutting board system with a cover element comprising a series of hinged panels features a base 1160 with an integrated food preparation surface. The base can be any of a variety of shapes, including square, rectangular, trapezoidal, rectangular, octagonal, or any of a variety of rectilinear shapes or, even in some embodiments a non-rectilinear shape. Along one side of the base, from corner to corner, a first panel 1110 is pivotally attached via connectors (such as hinges) 1116 such that it can be folded under the base 1160 or locked in a position that defines a plane substantially perpendicular to the food preparation surface 1160.

With the first panel 1110 in a locked position defining a plane substantially perpendicular to the base 1160, a second panel 1120 and third panel 1130 are pivotally attached to its vertical sides 1112, 1113 such that each such panel can be pivoted into a position defining planes substantially perpendicular to the plane defined by the first panel 1110 and communicating along an edge of the base component 1162, 1163 respectively. A fourth panel 1140 is pivotally adjoined along either edge of the second or third panel 1134 (shown connected to third panel 1130) that is distal to the first panel 1110 such that it is operable to communicate along an edge 1164 of the base component 1160 and define a plane substantially parallel to that which is defined by the first panel 1110.

A fifth, and final, panel 1150 is pivotally attached along the top edge 1115 of the first panel 1110 such that it can simultaneously communicate along the top edges 1115, 1125, 1135, 1145 of panels 1 through 4 when each is in a position that communicates with the base 1160. With each panel in a position and the fifth panel 1150 secured along the top edges 1115, 1125, 1135, 1145 of the other four panels, a box-like space is defined over the food preparation surface 1160.

Advantageously, a pivotally connected paneled embodiment of a dome component for a convertible cutting board system, such as that described herein, is operable to fold back upon itself and create a stack of nested panels that can be positioned beneath the food preparation base for compact storage when the system is not in use. Alternatively, when the system is being used to store food, the panels can be folded out of the way in order to gain access to the food.

It should be appreciated that other embodiments may be constructed from variations of the embodiment illustrated in FIG. 11. For instance, the pivotally connected panels may be attached to each other in a variety of manners. In addition, a varying number of panels and shapes may be used for different configurations. As an example, the base may be shaped as an equilateral triangle and each of the walls may similarly be shaped as an equilateral triangle and adjoin together to form a pyramid type structure. Alternatively, square or rectangular walls may be used with a triangular base to form a 3-D triangle shape when closed.

In another embodiment, a round base may be used with an expanding and collapsing canopy that is substantially parabolic in shape when fully expanded with the opening of the parabola coinciding with the round base. When collapsing such a canopy, the fully collapsed canopy would define an arch that extends from the edge of the round base and arches up and over the center of the round base. When collapsed, the canopy could be removed and then easily reattached.

In yet another embodiment of the convertible cutting board, a combination of pivotally mounted panels and an expanding/collapsing canopy may be utilized. For instance, a rear panel may be pivoted into position with a canopy attached thereto. Once the panel is secured into its position, the canopy can be expanded to complete the covering of the base unit.

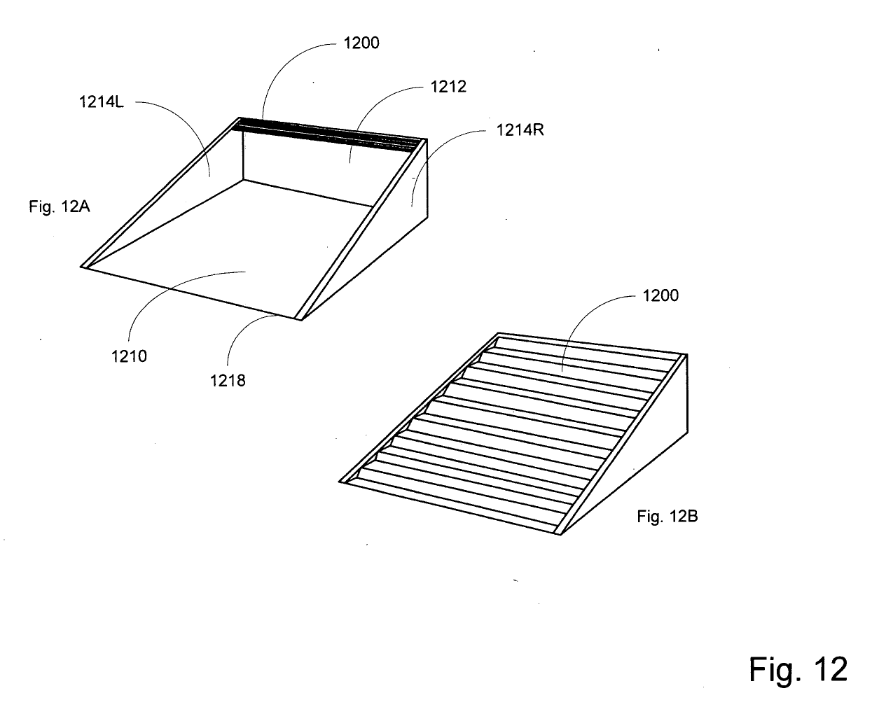

FIGS. 12A and 12B, collectively referred to as FIG. 12, are diagrams illustrating views of another embodiment of the convertible cutting board in an open state FIG. 12A and a closed state FIG. 12B. In this embodiment, a combination of walls or panels is used in conjunction with an expandable and collapsible canopy. It should be appreciated that the illustrated configuration is presented as a non-limiting example and that a wide variety of combinations of panels and canopies may be used in various embodiments. In the illustrated embodiment, a base 1210 is illustrated with a back wall 1212, a left side wall 1214L and a right side wall 1214R, collectively referred to as the walls. The walls can be fixedly attached to the base 1210, removably attached to the base 1210 or pivotally attached to the base 1210 or other walls, as well as a combination of any of these configurations.

A canopy 1200 is shown in FIG. 12A in its fully collapsed state and in FIG. 12B in its fully expanded state. In FIG. 12A, the canopy is attached to the upper portion of the rear wall 1212. The canopy can be expanded by pulling it towards the front 1218 of the base 1210. When fully expanded, the canopy can be attached to the base 1210 using one of the afore-described techniques or techniques that are similar thereto. It should also be appreciated that the canopy 1200 could also be attached to one of the side walls and then expand to the opposing side wall rather than expanding from the rear wall 1212 to the front of the base 1210.

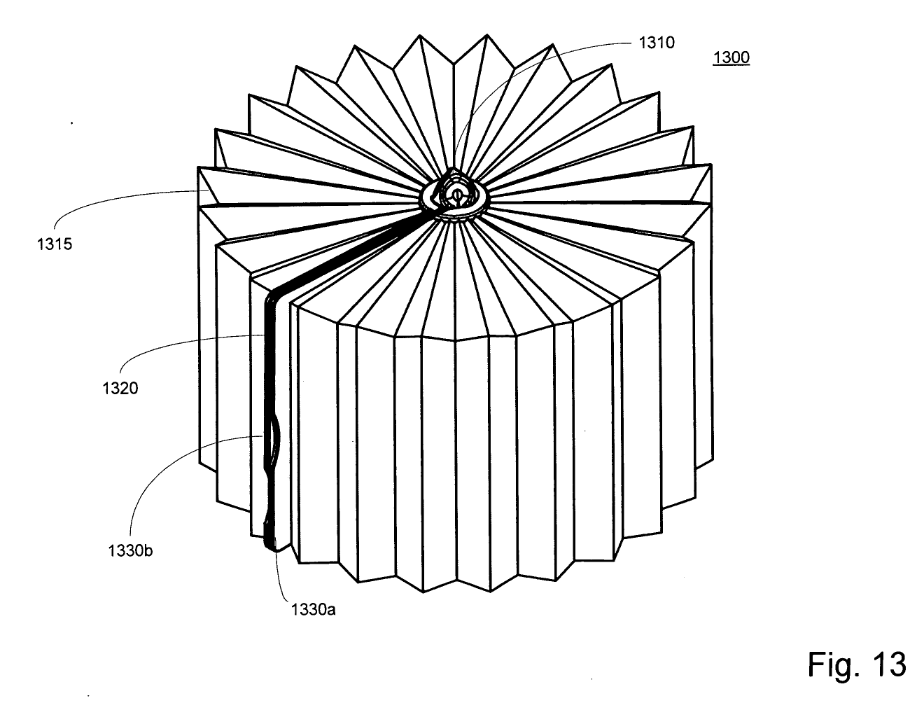

Moving now to FIG. 13, an alternative canopy aspect used in some embodiments of a convertible cutting board system is offered for exemplary purposes. As is common to embodiments of a convertible cutting board system, an embodiment incorporating the canopy aspect depicted in the FIG. 13 embodiment provides a food preparation surface (not shown) in conjunction with a means for defining a space useful for food storage. The particular canopy aspect illustrated in FIG. 13 is an independent component of a convertible cutting board system that is operable to be used with a plurality of food preparation surfaces. More particularly, in one embodiment the canopy in FIG. 13 is a stand-alone element that can be placed over a plate, on a table, over a cutting board or over any surface upon which a user desires.

FIG. 13 is a perspective view of an alternate canopy 1300 that may be incorporated in some embodiments. The alternate canopy 1300 includes a connector knob 1310, a canopy curtain or cover 1315, rigid or semi-rigid or stiff support arms (referred to herein as rigid support arms) 1330a and 1330b and a seal 1320 that interlocks the rigid support arms 1330a and 1330b.

In the FIG. 13 embodiment, as well as the other described embodiments, the cover or curtain 1315 may be constructed of a variety of materials including solid materials, mesh materials, porous materials, air-tight materials, transparent materials, translucent materials, opaque materials, etc. The canopy 1300 is depicted in a closed position in FIG. 13 and rotates horizontally between an open and a closed position. The connector knob 1310, as previously described relative to other embodiments, may be operable to “lock” the canopy into one of a variety of positions including and between fully open and fully closed. Further, the canopy 1300 in some embodiments is operable to mate with a releasable, mechanical seal 1320 along a plane determined by a radius of the space defined beneath the closed canopy 1300. The seal 1320 may be maintained through any number of mating profiles or techniques known in the art or previously disclosed herein.

The mating aspect of a canopy 1300 such as that illustrated in FIG. 13 may reside along the communicable surfaces of complimentary rigid support arms 1330a, 1330b. Importantly, it should be understood that for a canopy aspect such as that being presently described, the canopy 1300 may consist of a single curtain piece 1315 operable to extend circumferentially and define an enclosed space or, alternatively, it may comprise multiple curtain aspects each operable to extend over only a portion of the preparation surface and mechanically mate with adjacent curtain aspects along planes defined by the complimentary rigid support arms of each. The rigid support arms 1330a and 1330b are fixedly attached and are integral to, or are temporarily attached to, opposing ends of the cover or curtain 1315 of the canopy 1300. The rigid support arms 1330a and 1330b provide structural support to help the cover maintain a particular shape but, it should be appreciated that other techniques are also anticipated.

For instance, the cover itself may be constructed in such a manner so as to provide any necessary support. The cover 1315 illustrated in FIG. 13 includes a plurality of accordion-like folds, each of which can provide structural integrity to the canopy 1300 to help maintain a desired shape or to ensure a space is defined beneath the cover 1315. In addition, multiple support structures can be integrated into the curtain 1315 at various points. As a non-limiting example, for the embodiment in FIG. 13 at the apex of each accordion fold, a wire, bead or reinforcement material may be used to provide structural support.

Offered as another example of a variation for the cover element in some integral canopy embodiments, a canopy mechanism 1300 depicted in the FIG. 13 embodiment may be comprised of a rigid post structure (not shown) that is fixed to or rests upon a lower surface, such as a food preparation surface or base receiver as non-limiting examples, and oriented substantially perpendicular to the surface with an extension from its top protruding substantially parallel to, and out over, the surface such that accordion-like cover elements 1315 connected thereto via a connector knob 1310 can be opened/closed in a curtain-like fashion. Notably, a variation of the embodiment presently being described may provide for the rigid post structure (not shown) to extend perpendicularly from the center of food preparation surface such that the configuration may be useful in a “bundt” cake arrangement.

To reiterate, an integral canopied embodiment of a convertible cutting board system that incorporates a canopy aspect such as that depicted in FIGS. 13-15 requires a rigid post arrangement (not shown) operable to support the curtain/canopy aspect. It is anticipated that such a support structure may extend vertically from the center area of the embodiment's food preparation surface up to the underside of the anchor point of the locking mechanism/knob 1310. Alternatively, the support structure may originate from the edge of the embodiment and extend vertically in a space exterior to the canopy before extending horizontally over the canopy and attaching at the aforementioned anchor point. Further, the support structure could conceivably operate to itself define a portion of the space over the food preparation surface with one or more canopy aspects extending from its sides.

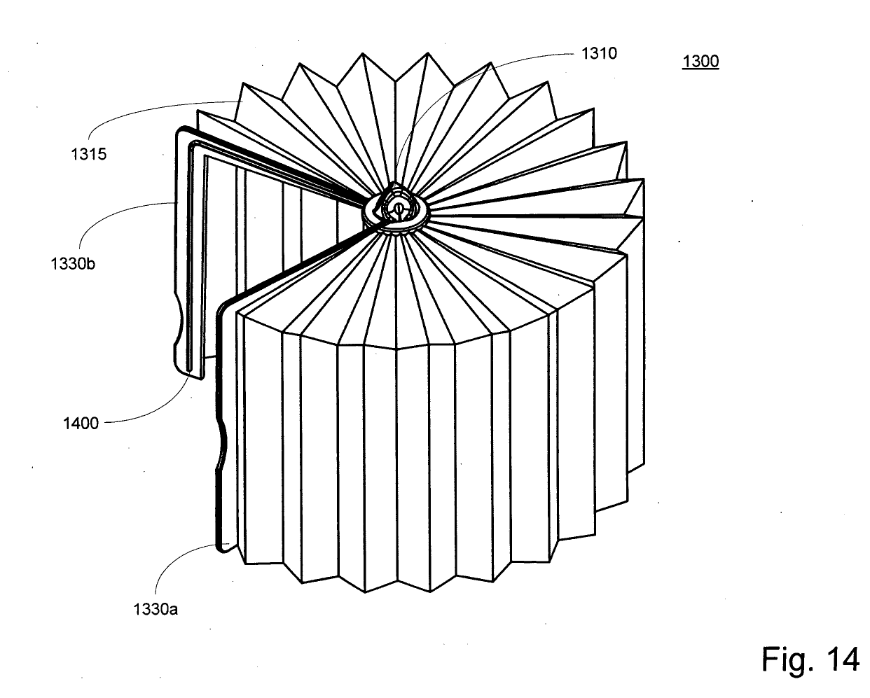

FIG. 14 is a perspective view of the same alternate canopy aspect described relative to FIG. 13, the alternate canopy being depicted in a partially open position. In the FIG. 14 illustration, the canopy 1300 is partially open and, therefore, the complimentary rigid support arms 1330a, 1330b can be seen in a non-mated position. Notably, as described prior, the complimentary rigid support arms 1330a, 1330b may be outfitted with means known in the art for affecting a mechanical seal, such as, but not limited to, a mated protrusion/indentation configuration 1400.

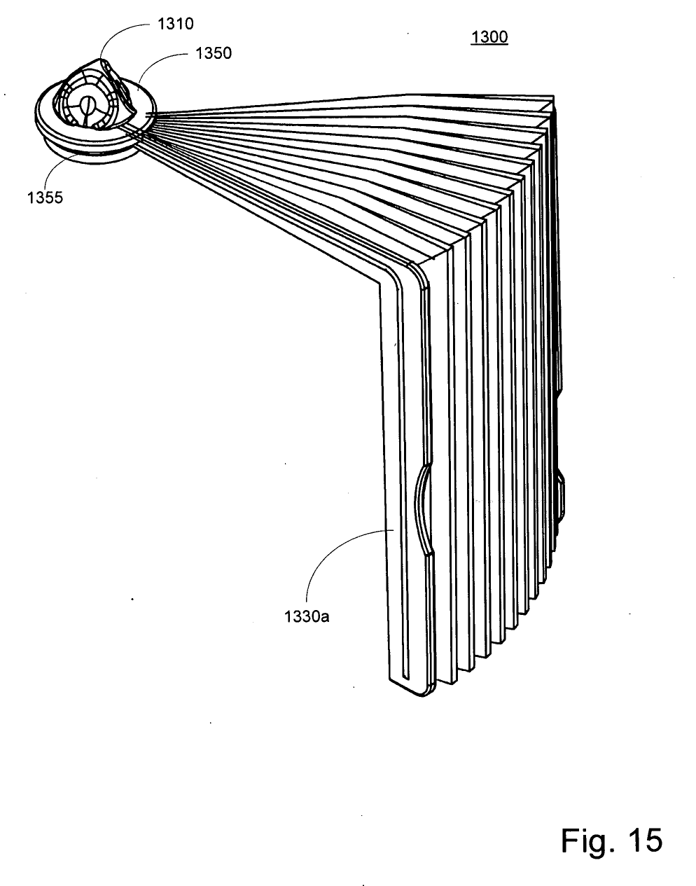

FIG. 15 is a perspective view of the same alternate canopy aspect described relative to FIG. 13, the alternate canopy being depicted in a substantially fully open position. In the FIG. 15 illustration, the same features and aspects described relative to FIG. 14 can be seen. Notably, the accordion-like arrangement of the canopy 1300 provides for compression of the canopy 1300 into an area represented by a fraction of that which is encompassed by the canopy 1300 when in a fully closed state (see FIG. 13).

The knob 1310 is shown as being integral to disk 1350 which includes a groove or track 1355. In one embodiment, a first the support arm (i.e., 1330a) is integral with or attached to the knob 1310 while the second support arm (i.e., 1330b) is integral with or attached to the disk 1350. In operation, as the knob 1310 is rotated, the first support arm rotates along with the knob relative to the second support arm. Thus, the knob 1310 rotates freely within the disk 1350. Various structures for such a mechanism are anticipated such as utilizing an axel extending from the underside of the knob 1310 through bore or hole in the disk 1350 and then being secured underneath to prevent it from easily being retracted. The axel in such an embodiment has a diameter that is less than the diameter of the bore to allow the knob to freely rotate. In more complicated embodiments, the knob may be spring loaded, may include ratchet like indentions to define a plurality of positions in which the knob can be placed and held into position, or may include other locking type mechanism all of which are anticipated as being applicable to the various embodiments.

Variations of the embodiment illustrated in FIGS. 13-15 are anticipated. For instance, all though the illustrated embodiment has primarily been described as being disk shaped or Bundt-like shaped, it should be appreciated that any of a wide variety of shapes may created using variations of the disclosed techniques. For instance, as non-limiting examples a few other shapes in which the canopy may be created include dome shapes, cone shapes, mushroom shapes, shapes with wavy profiles, various concave and convex shapes as well as combinations thereof, rocket shapes, etc.

In addition, the various embodiments of the canopy may be integral to or operate in conjunction with a lower surface, which could be a cutting board, a dish, or any of a variety of other surface uses. For instance, in one variation the lower surface may include a track or indentation that the cover 1315 follows as it rotates horizontally between an open and closed position. Such a track or indentation may help to improve an air-tight seal.

In some embodiments, the canopy 1300 may be attached to a board, dish or container during use and then removed for storage or cleaning. Further, the board, dish or container may include a recess on its bottom side that is suitable for storing the fully retracted canopy. In other embodiments, the canopy can be mounted to the board, dish or container in such a manner that when fully retracted, the canopy 1300 can be swiveled underneath the board, dish or container for storage or, alternatively, swiveled down to the upper surface of the board, dish or container.

It is also anticipated that the canopy of embodiment presently being described, as well as canopy elements of other embodiments, may operate only as a top or lid for a container, such as a bowl, pot, etc. In this embodiment, the canopy may include the knob and support arms that extend in a radial fashion to define a lid-like shape when the cover is rotated to a fully extended position. Further, in such embodiments an exterior ring may also be incorporated into the embodiment such that the cover tracks along the perimeter of the ring as it is rotated from an open to a closed position and vice versa. The ring, for example, may be constructed in such a manner to mate with, and even form a seal with an opening of a bowl, pan, pot, dish etc.

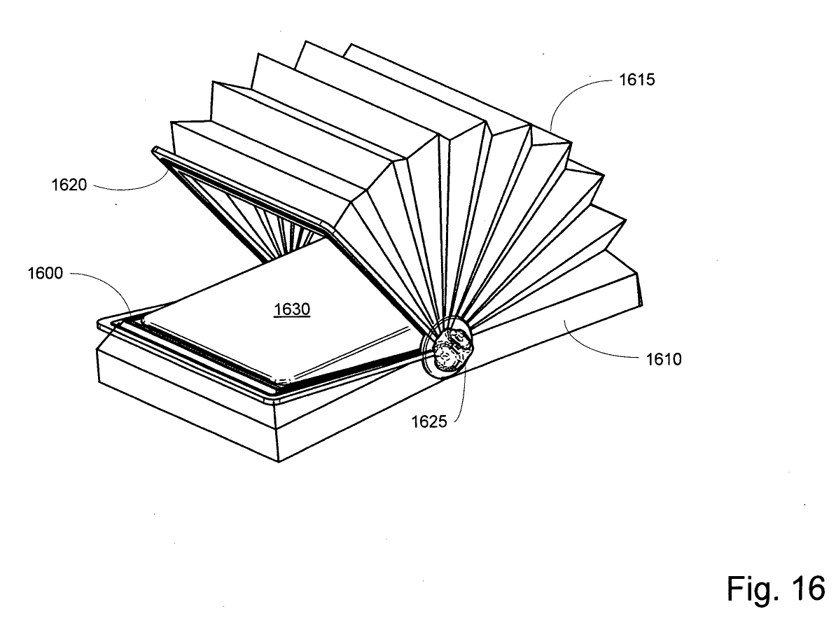

Moving now to FIG. 16, a perspective view is shown of an embodiment of a food preparation surface having a sealable open/close cover arrangement, the cover arrangement being comprised of a single canopy. Similar to that which was described relative to FIGS. 1-10, the embodiment illustrated in FIG. 16 comprises a base structure 1610 with an integral, or separable, food preparation surface 1630. The cover element 1615 depicted in the FIG. 16 embodiment, however, is comprised of a single, accordion-like component that is fixed at one end of the base 1610 and anchored 1625 along an axis substantially in the center of the food preparation surface 1630. A leading edge 1620 of the cover element 1615 provides rigidity and is fitted with a profile that is operable to communicate with a complimentary profile 1600 at the opposite end of the base 1610 from where the canopy 1615 is fixed. Advantageously, the leading edge 1620 of the single canopy element 1615 can communicate with the fixed complimentary profile 1600 to affect a seal.

With the exception of the single component canopy element, the embodiment illustrated in FIG. 16 may embody or include some or all of substantially the same features, functionality, and component variations as that which has been disclosed relative to previous embodiments. FIG. 16 is offered as a non-limiting example of a variation in overall product shape and cover component design. Importantly, the cover element in various embodiments of a convertible cutting board system may be comprised of a single, or multiple, components as may be required for the specific functionality of an embodiment.

It should be noted that not all potential features of the convertible cutting board system, cover or cutting board cover are necessarily depicted in the exemplary figures and such is not intended to limit the scope. For instance, a tab or strap feature, which is not shown in the figures, could be included in some embodiments so that a fully retracted cover element could be prevented from inadvertent extension while the system is in use. Also, in addition to that which has been disclosed concerning heating, cooling, and moisture control aspects of some embodiments, the base or food preparation surface components in other embodiments may comprise features such as embedded electric heating elements or passageways for circulating a cooling media. Further, the food preparation surface itself may contain surface undulations or depressions, have water absorption properties, or exhibit natural heat transfer properties useful for defrosting food. Also, the cover element may be operable to affect an air-tight seal and/or be constructed of a transparent or translucent material.

The preceding list of examples of possible features for various embodiments of the convertible cutting board system is not meant to be exhaustive or exclusive. Various aspects, features and characteristics of the present invention have been described. Not all of the aspects, features or characteristics are required for each and every embodiment of the present invention. However, it will be appreciated that the various aspects, features, characteristics and combinations thereof may be considered novel in and of themselves.

What is claimed is:

1. An apparatus comprising:
a substantially horizontally oriented surface element;
a cover element mechanically coupled to at least one edge of said surface element, wherein said cover element is:
operable to define a space over and to cover said surface element when residing in a first state;
operable to retract to a second state wherein said surface element is exposed; and
operable to create a seal around the perimeter of said surface element when residing in said first state.

2. The apparatus of claim 1, wherein said cover element comprises two components that are pivotally mounted to the surface element.

3. The apparatus of claim 1, wherein the material of construction for said surface element has physical properties useful for food defrosting.

4. The apparatus of claim 1, wherein the material of construction for said surface element has physical properties useful for water absorption.

5. The apparatus of claim 1, wherein said surface element further comprises a raised profile of feet on its underside making it operable to minimize contact with another surface.

6. The apparatus of claim 1, wherein said surface element comprises features on its underside operable to create a coefficient of friction useful to minimize sliding.

7. The apparatus of claim 1, wherein said cover element is comprised of a material that is alternately creased in an accordion-like manner such that said cover element can move from a fully expanded state to a fully collapsed state.

8. The apparatus of claim 7, wherein said surface element has a first end and a second end and the alternately creased cover element is comprised of a first component being associated with the first end of the surface element and a second component being associated with a second end of the surface element, the first component and the second component being pivotally attached to the surface element about an axis lateral to the surface element wherein the first and second components are expandable about the axis to be communicable to one another at a plane substantially perpendicular to a plane defined by said surface element.

9. The apparatus of claim 8, wherein said communication between first component of the cover element and the second component of the cover element operates to create a substantially air-tight seal.

10. The apparatus of claim 1, wherein said surface element is of a rectilinear shape and said cover element is comprised of a series of panels pivotally attached to the surface element and operable to fold into a stack to expose said surface area such that:
a first panel is pivotally attached at its base along a first edge of said surface element and is operable to pivot between a first position that is on a plane substantially perpendicular and vertical to a plane defined by said surface element and a second position that is parallel to the surface element;
a second panel is pivotally attached to the first panel along a first edge perpendicular to the base and is operable to pivot between a first position and a second position, the first position of the first panel being on a plane substantially perpendicular and vertical to the plane defined by said surface element and perpendicular to the first panel while said first panel is residing in the first position, and the base of said second panel corresponding to a second edge of said surface element that is perpendicular to said first edge, and the second position being parallel to the surface element;
a third panel is pivotally attached to the second panel along a first edge of the second panel that is opposite the edge upon which the second panel is pivotally attached to the first panel and is operable to pivot between a first and a second position, the first position of the third panel being on a plane substantially perpendicular and vertical to the plane defined by said surface element and parallel to the first panel while said first panel is residing in the first position, and the base of said third panel corresponding to a third edge of said surface element that is perpendicular to the second edge and parallel with the first edge of the surface element;
a fourth panel is pivotally attached to the first panel along a second edge perpendicular to the base and parallel to the first edge of the first panel and is operable to pivot between a first position and a second position, the first position of the fourth panel being on a plane substantially perpendicular and vertical to the plane defined by said surface element and perpendicular to the first panel while said first panel is residing in the first position, and the base of said fourth panel corresponding to a third edge of said surface element that is perpendicular to said first edge, and the second position being parallel to the surface element;
a fifth panel that is pivotally attached to the first panel along a third edge of the first panel that is parallel to the base and perpendicular to the first edge and the second edge, and is operable to pivot between a first position and a second position, the first position of the fifth panel being on a plane substantially parallel to the plane defined by said surface element and perpendicular to the first panel while said first panel is residing in the first position, and the second position being parallel to the first panel.

11. The apparatus of claim 10, wherein when the panels are all residing in the first position, that they can be connected to form a substantially airtight seal.

12. The apparatus of claim 10, wherein when components are in said first position, the communication among panels and surface element is secured with magnetism.

13. The apparatus of claim 1, wherein the material of construction for said cover element is transparent or translucent.

14. The apparatus of claim 1, wherein at least a portion of said surface element is separable such that it can be cleaned.

15. An apparatus that includes a base and a canopy, wherein the canopy can be moved between an open and closed position respectively providing access to the base or defining a closed-in void above the base, the apparatus comprising:
a first canopy component that includes a fixed edge and a moveable edge, the fixed edge of the first canopy component being attached to a first portion of the base and the moveable edge of the first canopy component including a seal protrusion;
a second canopy component that includes a fixed edge and a moveable edge, the fixed edge of the second canopy component being attached to a second portion of the base and the moveable edge of the second canopy component including a seal receptacle; and
the first and second canopy components including ends that are pivotally attached to opposing sides of the base and being concentric with an axis that runs parallel to the plane of the base, wherein the first and second canopies can be pivoted between a first position in which the moveable edge of the first canopy mates with the moveable edge of the second canopy and a second position in which the first and second canopy are collapsed relative to the respective fixed edges.

16. The apparatus of claim 15, wherein the canopies operate to form an air-tight seal when in said first position.

17. The apparatus of claim 15, wherein said canopies are comprised of a material that is alternately creased in an accordion-like manner such that said canopies are collapsed upon themselves when in said second position.

18. The apparatus of claim 15, wherein the movable edges comprise magnets.

19. The apparatus of claim 15, further comprising a means for securing said canopies in said second position such that said canopies cannot inadvertently pivot toward said first position.

20. A cover apparatus operable to define a space over and to cover a surface when residing in a first state and operable to retract to a second collapsed state wherein said surface is exposed comprising:
a first and a second rigid support arm mounted to a knob structure in such a manner to be rotatable about the knob structure relative to each other; and
a cover having a first end and a second end, the first end being attached to the first support arm and the second end being attached to the second support arm;
wherein as the first and second rigid support arms are rotated relative to each other, the cover can be transitioned from an open position to a closed position thereby providing a cover to the surface.
